(19) United States
(12) Patent Application Publication
(10) Pub. No.: US 2012/0275890 A1
(43) Pub. Date: Nov. 1, 2012

(54) PALLET ACCESSORY FOR TRUCK-MOUNTED CRANE

(76) Inventor: Paul Seales, Port Isabel, TX (US)

(21) Appl. No.: 13/457,943

(22) Filed: Apr. 27, 2012

Related U.S. Application Data
(60) Provisional application No. 61/480,184, filed on Apr. 28, 2011.

(51) Int. Cl. B66C 23/42; B66C 1/16; B60P 1/54

(52) U.S. Cl. 414/542; 294/67.4; 212/295

(57) ABSTRACT

A sling for lifting pallet-mounted cargo includes: an upper pair of telescopic beams; a yoke connecting the upper beams; a lower pair of telescopic beams; and load lines connecting each of the upper beams to a respective lower beam. The sling may further include adjustable hangers connecting the load lines to the upper beams.

### CROSS-REFERENCE TO RELATED APPLICATIONS

This application claims benefit of U.S. Provisional App. No. 61/480,184 (Atty. Dock. No. GRIZ/0003USL), filed Apr. 28, 2011, which is hereby incorporated by reference in its entirety.

### BACKGROUND OF THE INVENTION

1. Field of the Invention

Embodiments of the present invention generally relate to a pallet accessory for a truck-mounted crane.

2. Description of the Related Art

Loading and unloading cargo onto/from trucks has typically been accomplished using a forklift. A forklift is an expensive and cumbersome piece of equipment. When picking up or delivering cargo to/from locations in the field, a forklift has to be transported with the truck. Transporting the forklift requires towing a trailer.

### SUMMARY OF THE INVENTION

Embodiments of the present invention generally relate to a pallet accessory for a truck-mounted crane. In one embodiment, a sling for lifting pallet-mounted cargo includes: an upper pair of telescopic beams; a yoke connecting the upper beams; a lower pair of telescopic beams; and load lines connecting each of the upper beams to a respective lower beam.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a truck-mounted crane, according to one embodiment of the present invention.

FIGS. 2A-2C illustrate operation of the truck-mounted crane. FIG. 2A illustrates the truck-mounted crane in the vertical position hoisting cargo. FIG. 2B illustrates the truck-mounted crane in an intermediate position. FIG. 2C illustrates the truck-mounted crane in a horizontal position having loaded the cargo onto the truck.

FIG. 3 illustrates a sling for operation with the truck-mounted crane, according to another embodiment of the present invention. FIGS. 3A-3E are enlargements of portions of FIG. 3.

FIG. 4 illustrates operation of the sling with the truck-mounted crane.

### DETAILED DESCRIPTION

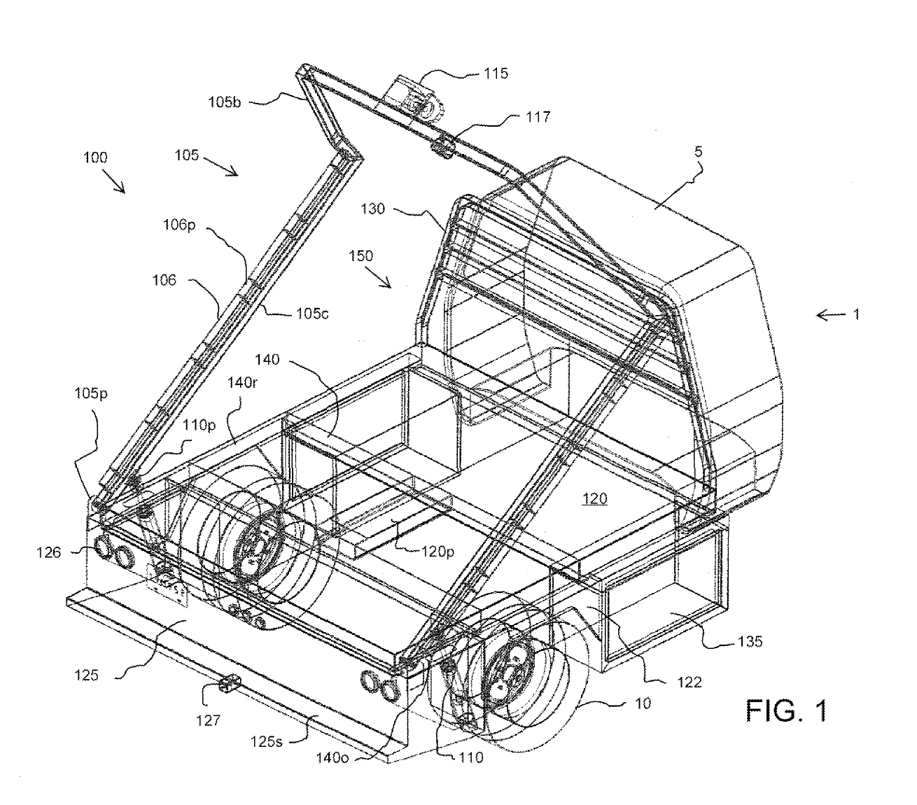

FIG. 1 illustrates a truck-mounted crane 100, according to one embodiment of the present invention. The crane 100 may be fastened to a chassis of a pickup truck 1, such as a chassis cab truck. The truck 1 may include a cab 5, such as a standard, extended, or crew cab. The truck 1 may further include an engine (not shown), such as a gasoline, diesel, hybrid, or natural gas. The front portion of the truck 1, especially the engine, may serve as a counterweight for the crane 100. The cab 5 may further include a steering wheel, a driver's seat, such as a chair or bench, a gear shifter, an accelerator pedal, a brake pedal, and other instruments and controls. The truck 1 may further include a transmission, such as a standard or automatic, a drive shaft, a rear differential, and two or more axles. The truck 1 may further include four or more wheels 10, such as six. The truck 1 may be rear wheel drive or four wheel drive. Alternatively, the crane 100 may be mounted on a trailer, such as a low-boy or flat bed and may include a counterweight.

The crane 100 may include a boom 105, a boom hoist 110, a load hoist 115, and a base 150. The base 150 may include a cargo bed 120, a rear bumper 125, cab protector 130, one or more utility boxes 135, a frame 140, power unit (not shown), and controller (not shown). The crane 100 may have a load capacity corresponding to a cargo capacity of the truck 1, such as greater than or equal to one-half ton, three-quarter ton, one ton, one and one-half ton, or two tons.

The boom 105 may include one or more structural members, such as columns 105c and beams 105b. The boom 105 may be made from a high strength metal or alloy, such as steel. The steel may be plain carbon, low alloy, high strength-low alloy or stainless. The structural members 105b,c may be rectangular (i.e., square) tubing or other structural shapes, such as C, L, I, or pipe. The structural members 105b,c may be welded together or fastened together, such as using bolts and nuts. The boom 105 may be pivoted 105p to the frame 140 using fasteners and bearings or bushings. The pivots 105p may be located at a rear end of the frame 140. The boom 105 may form a three dimensional shape. The columns 105c may be parallel to a longitudinal axis of the truck 1 in the horizontal position and may be spaced apart a distance corresponding to the width of the cab 5, such as five to nine feet. A length of each column 105c may correspond to a length of a cargo portion of the chassis, such as six to sixteen feet. The beams 105b may form a shape conforming to a shape of the cab 5 and cab protector 130, such as an isosceles trapezoid (minus the long base). A height of the trapezoidal portion may correspond to a height of the cab above the cargo portion of the chassis, such as two to six feet.

The boom 105 may further include a rail 106 fastened or welded to each column 105c. Each rail 106 may be disposed along an outer surface of each column 105c. Each rail 106 may have stake pockets 106p formed therein and the stake pockets may be spaced along each rail at regular intervals. The stake pockets 106p may receive stakes (not shown) for securing the cargo 205. The rails 106 may be made from any of the materials and shapes discussed above for the columns 105c and beams 105b.

The boom 105 may be rotated about the pivots 105p relative to the base 150 between a vertical position and a horizontal position by the boom hoist 110. The boom hoist 110 may include one or more hydraulic piston and cylinder assemblies 110 (PCAs). A first end of each PCA 110 may be pivoted 110p to each column 105c and a second end of each PCA may be pivoted to the frame 140. Extension of each PCA 110 may raise the boom 105 and retraction of each PCA may lower the boom. Alternatively, an electric motor and lead screw may be used instead of each PCA 110.

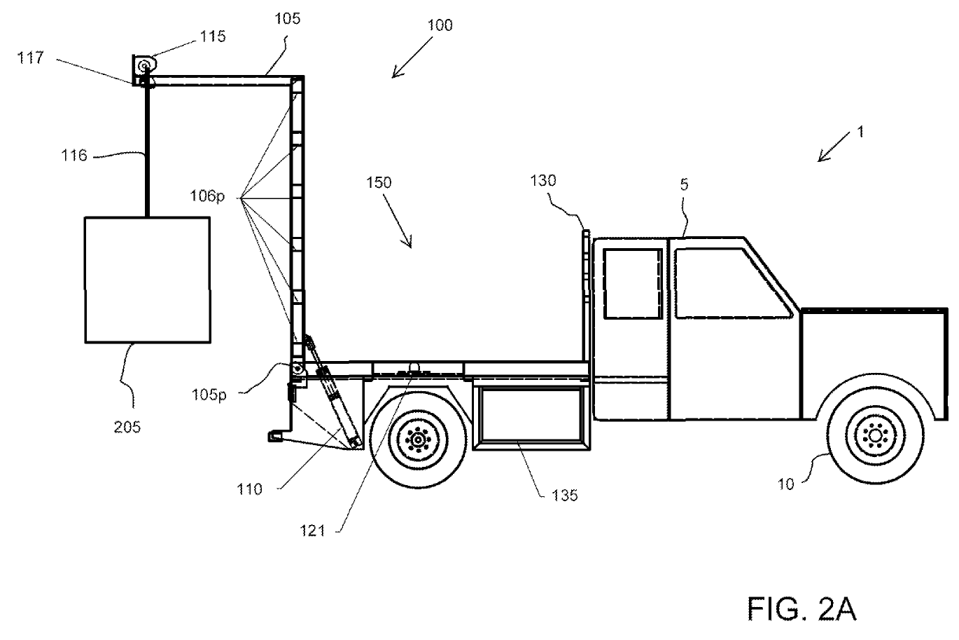

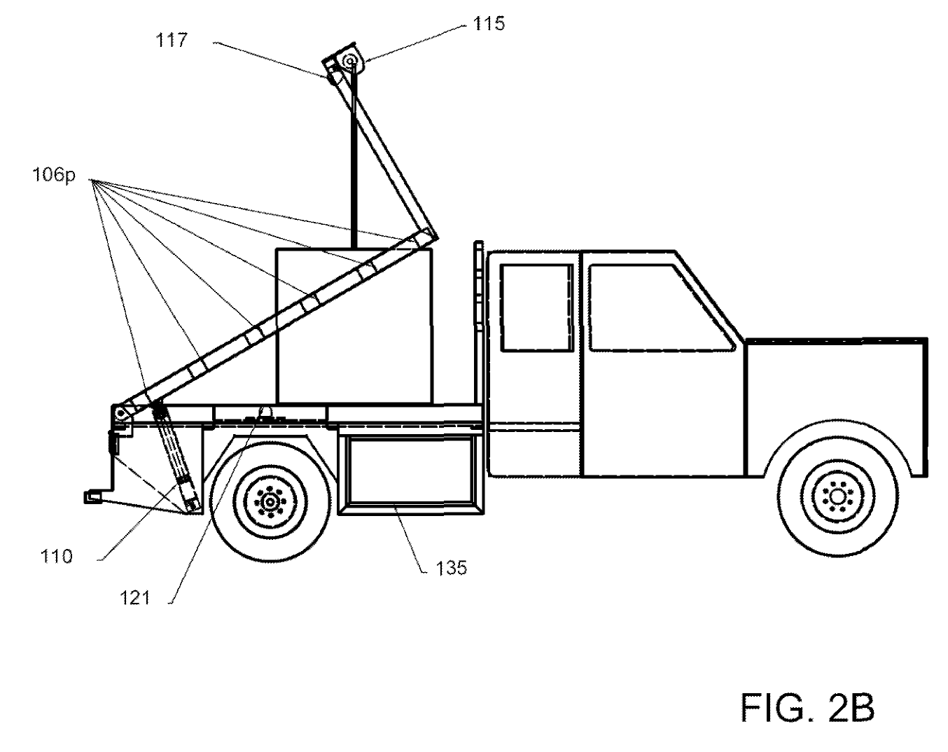

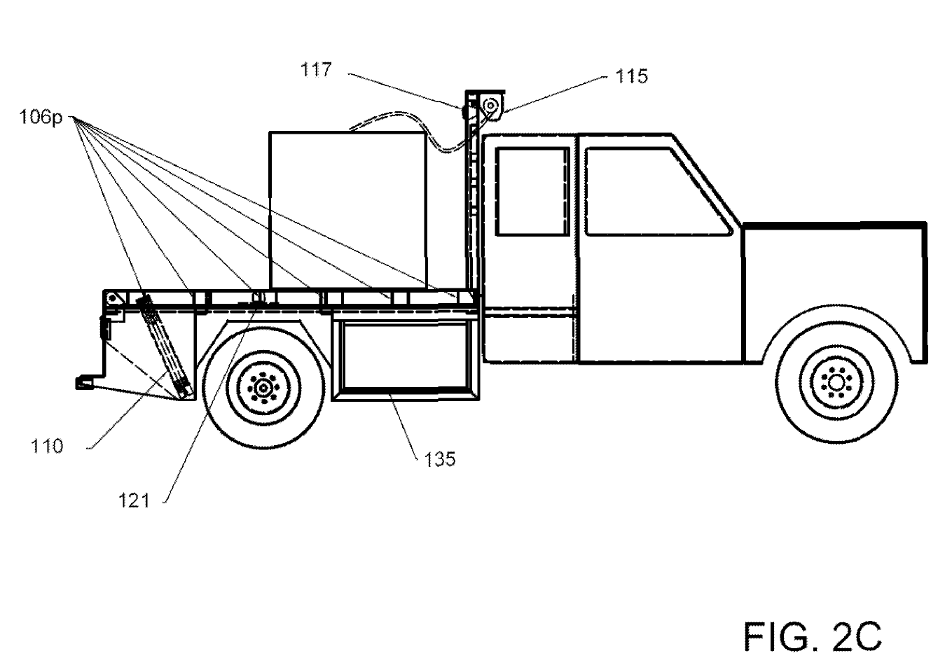

The bed 120 may be a rectangular plate formed from any of the boom materials, discussed above. A width of the bed 120 may correspond to a width of the cab. A length of the bed 120 may correspond to a length of a cargo portion of the chassis. The bed 120 may extend past the chassis to cover the bumper 125. The bed 120 may have a pocket 120p formed therein. A trailer hitch ball 121 (see FIG. 2A) may be disposed in the pocket 120p and fastened to the frame 140 sub-flush with the bed so as not to interfere with cargo hauling. The trailer hitch ball 121 may receive a gooseneck of a trailer (not shown).

The frame 140 may be fastened or welded to the bed 120 and may be fastened to the truck chassis. Alternatively, the frame 140 may be welded to the chassis. The frame 140 may be made of any of the shapes and materials discussed above for the boom 105. The frame 140 may form a recess 140r. Each recess 140r may receive a corresponding column 105c and rail 106 in the horizontal position so that the column and rail is flush or substantially flush with the bed 120. The frame 140 may have an opening 140o formed through a surface defining the recess 140r for passage of each PCA 110. Alternatively, the crane 100 may be manufactured with the truck 1 so that the chassis and the frame 140 may be integral.

The cab protector 130 (a.k.a. headache rack) may serve to protect a rear window of the cab 5 from shifting cargo 205. The cab protector 130 may be made from columns and beams and have an outer shape conforming to the cab shape, such as an isosceles trapezoid. The columns and beams may be any of the shapes and materials discussed above for the boom 105. The cab protector 130 may be coupled to the bed 120 by reception of column ends by stake pockets formed in the bed. Alternatively, the cab protector 130 may be fastened or welded to the bed 120 or frame 140.

The base 150 may further include panels 122. The panels 122 may be made from plates or sheets formed from any of the boom materials, discussed above. The panels 122 may be welded or fastened to the frame 140.

The bumper 125 may be made from plate formed from any of the boom materials, discussed above. A width of the bumper 125 may correspond to a width of the cab 5. The bumper 125 may be fastened or welded to the frame 140 and/or the chassis. The bumper 125 may have one or more compartments formed therein. The bumper 125 may include a compartment for each PCA 110. The bumper 125 may further include another compartment to house the power unit and controls. Tail lights 126 may be fastened to the bumper 125. A hitch receiver 127 may also be fastened or welded to the bumper 125. The bumper may form one or more steps 125s to facilitate climbing of the driver onto the bed 120.

The power unit may include a hydraulic fluid reservoir, a hydraulic pump operable to pressurize the hydraulic fluid, a manifold (including valves), and a hydraulic conduit. The hydraulic pump may be electric and compatible with the truck's accessory power system, such as twelve VDC. Alternatively, the hydraulic pump may be located in the engine compartment and connected to the crankshaft via the serpentine belt. Alternatively, the hydraulic pump may be driven by a power take off shaft connected to the powertrain at any location therealong, such as at the transmission (rear wheel drive or four wheel drive) or transfer case (four wheel drive). In either alternative, a clutch may be in communication with the controller to selectively engage the hydraulic pump with the engine or transmission. A hydraulic conduit, such as tubing, may extend from the manifold to each PCA 110. The manifold may be in fluid communication with an outlet of the pump and the reservoir. An inlet of the pump may be in fluid communication with the reservoir. The controller may be operably coupled to the pump and the manifold valves.

The load hoist may be a winch 115 fastened to the boom 105. The winch 115 may be fastened to a beam 105b parallel to a width of the truck at a center of the beam 105b. The winch 115 may include a load line 116, such as wire rope, a drum having the wire rope wrapped there-around, a housing, a motor, and a brake. The wire rope may be made from a high strength metal or alloy, such as high strength-low alloy steel, tool steel or spring steel. The motor may be electric and compatible with the truck's accessory power system. Alternatively, the motor may be hydraulic. An electrical conduit (not shown) may lead within or along the boom 105 to the controls. The crane 100 may further include a floodlight 117 fastened to the boom 105. Another electrical conduit may lead from the floodlight 117 to the controls within or along the boom.

The controller may include a driver-operable interface, such as levers or buttons, for selectively operating the PCAs 110, the load hoist 115, and the floodlight 117. The controller may plug into and be compatible with the truck's accessory power system. The controller may be located in a side compartment of the bumper 125 so that the driver may stand clear of the cargo 205 as it is being hoisted and loaded.

The utility boxes 135 may each be fastened or welded to the frame 140. The utility boxes 135 may be made from plate or sheet formed from any of the boom materials, discussed above. Each utility box may include a door (not shown) having a lock. The utility boxes 135 may stow stakes, chains, and/or straps for securing the cargo 205 once the cargo is hoisted and loaded. The utility boxes 135 may also stow one or more hoisting accessories (not shown) for the load line 116, such as a sling 300, or one or more accessories for the boom, such as cross-braces, for loading a bail of hay.

FIGS. 2A-2C illustrate operation of the truck-mounted crane 100. FIG. 2A illustrates the truck-mounted crane 100 in the vertical position hoisting cargo 205. FIG. 2B illustrates the truck-mounted crane 100 in an intermediate position. FIG. 2C illustrates the truck-mounted crane 100 in a horizontal position having loaded the cargo 205 onto the truck 1.

The cargo 205 may include items, such as hay bails, animal carcasses, or a sump pump. Once the driver has backed the truck 1 into proximity of the cargo 205, the driver may park the truck. The driver may then exit the truck 1 and access the controller. The driver may then raise the boom 105 to the vertical position by operating the PCAs 110. The boom 105 may extend longitudinally away from the truck 1 in the vertical position, thereby placing the winch 115 at a position to hoist the cargo 205 located proximately behind the bumper 125. The driver may then operate the winch 115 to lower the load line 116 to the cargo 205. The driver may then fasten the load line 116 to the cargo 205. The driver may then operate the winch 115 to hoist the cargo 205 such that a bottom of the cargo is aligned or just above the bed 120.

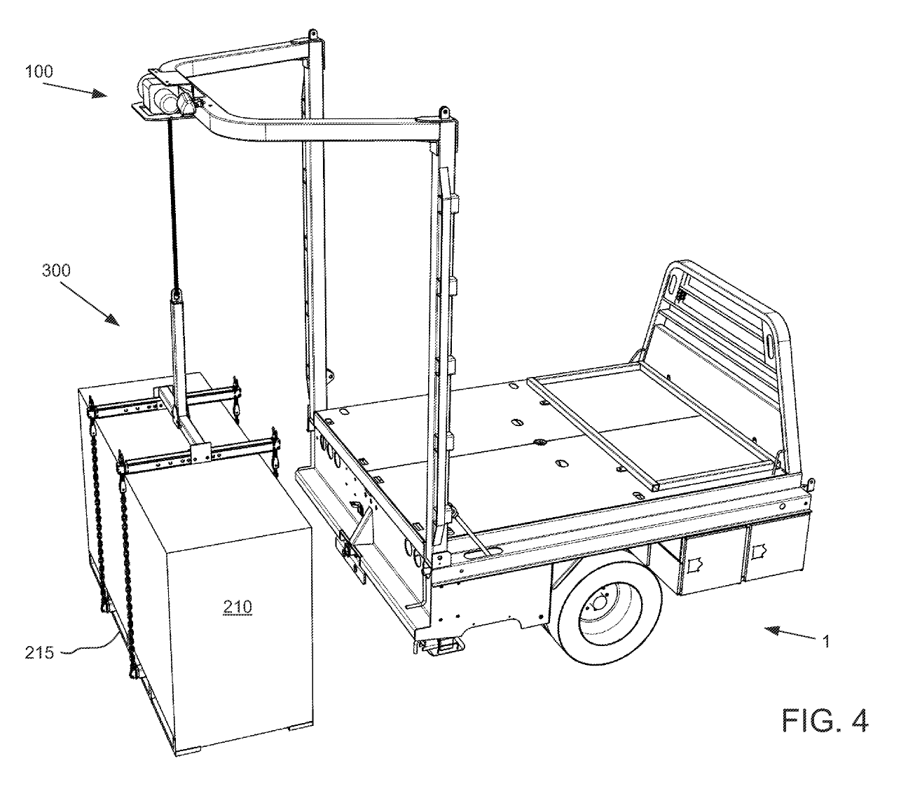

The driver may then operate the PCAs 110 to move the boom 105 to the horizontal position. As the boom 105 is lowered to the horizontal position, the winch 115 may carry the cargo 205 forward along a longitudinal path toward the cab 5 until the cargo rests on the bed 120, thereby also loading the cargo onto the truck 1. The winch 115 may rest at a position proximate to a rear end of the cab 5 in the horizontal position. Once in the horizontal position, the driver may secure the cargo 205 to the frame 140. The load line 116 may be left connected to the cargo 205 and serve as a back-up should the cargo break-free of tie-downs. The driver may enter the truck 1 and transport the cargo 205. Once reaching the destination, the driver may unload the cargo by reversing operation of the crane 100. A lifting hook (not shown, see FIG. 4A of the '184 application) may be fastened to an eye splice formed in an end of the load line 116.

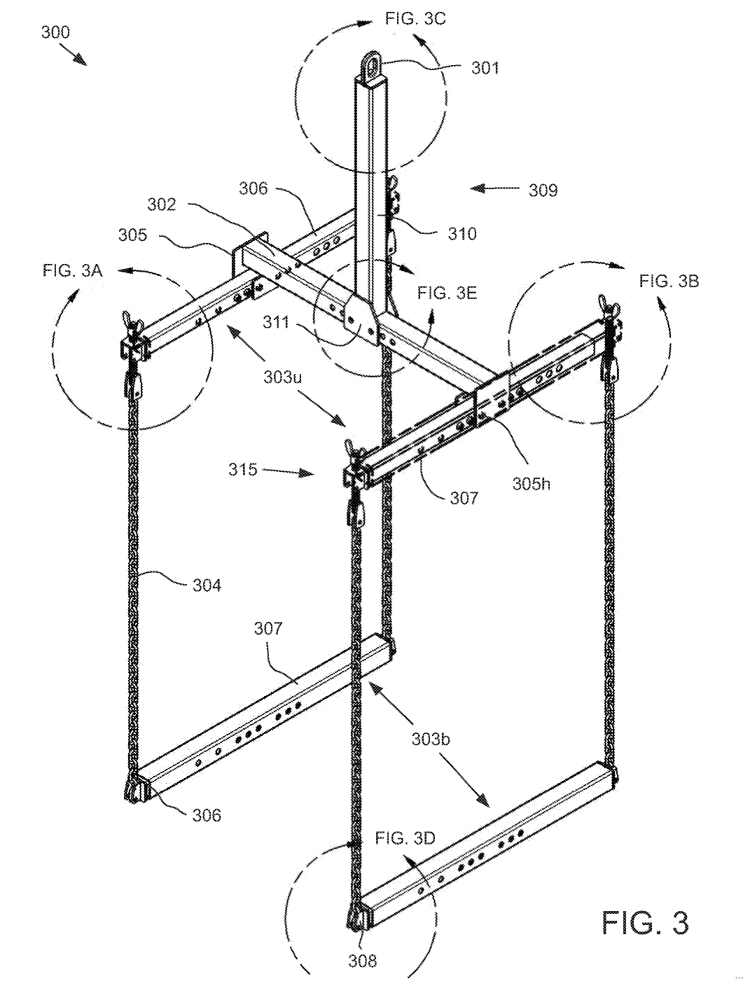

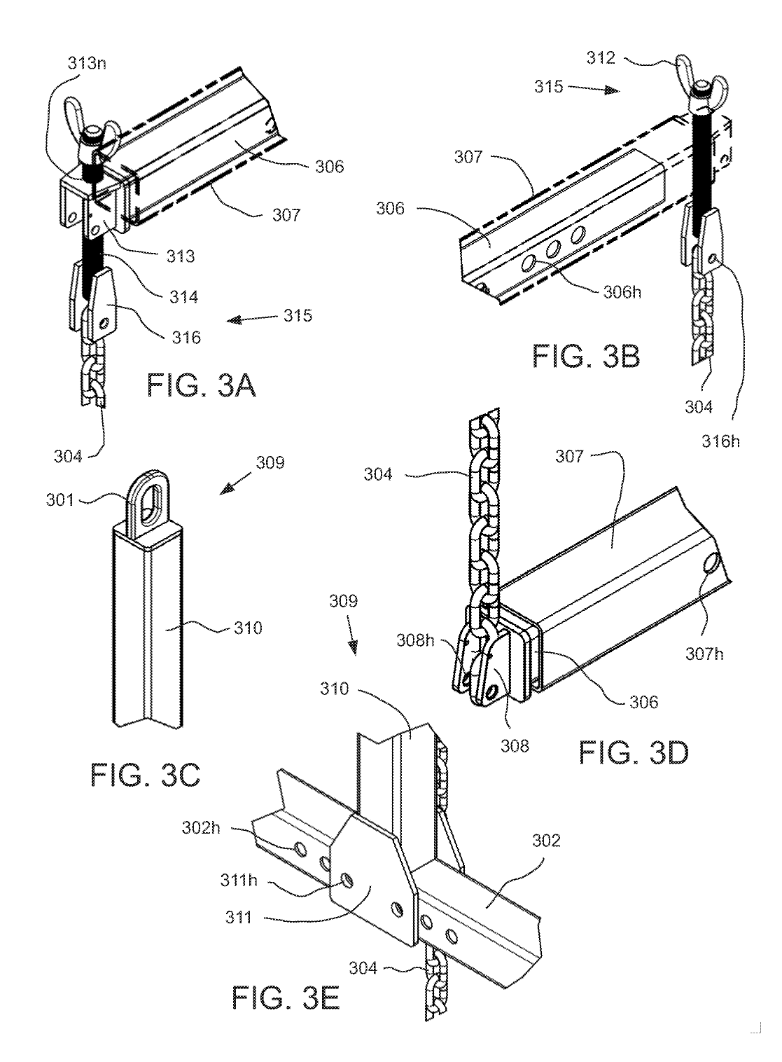

FIG. 3 illustrates a sling 300 for operation with the truck-mounted crane 100, according to another embodiment of the present invention. FIGS. 3A-3E are enlargements of portions of FIG. 3. The sling 300 may be operable to engage a pallet 215 (FIG. 4) and cargo 210 resting on the pallet so that the crane 100 may lift the cargo and pallet and load the cargo and pallet onto the truck 1.

The sling 300 may include structural members, such as: a lifting tongue 309, a yoke 302, and two or more (four shown) beams 303u,b; and two or more (four shown) load lines 304. The structural members may be any of the structural shapes, discussed above for the crane 1, and may be made from any of the boom materials, discussed above. The tongue 309 may include a lifting eye 301, a body 310, and a bracket 311. The lifting eye 301 may include one or more plates (eye plate and base plate shown) connected to an upper end of the body 310, such as by welding, and may receive the lifting hook connected to the crane load line 116. The bracket 311 may include two or more plates and may be connected to a lower end of the body 310, such as by welding.

The yoke 302 may have a set of holes 302h formed laterally therethrough and spaced therealong and the bracket 311 may have one or more (two shown) holes 311 h formed laterally through the plates thereof. A location of the tongue 309 may be adjusted to suit a particular pallet 215 and/or cargo 210 by moving the bracket 311 longitudinally relative to the yoke and inserting a beam fastener (not shown, see FIG. 4A of the '184 application) into aligned holes. The beam fastener may be a pin and clip, bolt and nut, or stud and nuts.

Alternatively, the lifting eye discussed and illustrated at FIGS. 3A and 3B in the '184 application may be used instead of the tongue 309.

The beams 303u,b may include a pair of upper beams 303u and a pair of lower beams 303b. Each beam 303u,b may be a telescopic assembly including an inner mandrel 306 and an outer housing 307 (housings 307 of upper beams 303u shown in phantom). Each housing 307 may have a set of holes 307h formed laterally therethrough and spaced therealong and each mandrel 306 may have a corresponding set of holes 306h formed laterally therethrough and spaced therealong. A length of each beam 303u,b may be adjusted to suit a particular pallet 215 and/or cargo 210 by moving the mandrel 306 longitudinally relative to the housing 307 and inserting (another) beam fastener into aligned holes.

The yoke 302 may have a bracket 305 connected at each end thereof, such as by welding, for receiving a respective one of the upper beams 303u. Each bracket 305 may include two or more plates and one or more (two shown) holes 305h formed laterally through the plates. Each bracket 305 may be fastened to a respective upper beam 303u using the same respective beam fastener used to fasten the respective upper housing 307 and mandrel 306. A location of the yoke 302 may be centralized relative to the particular beam adjustment by moving the brackets 305 longitudinally relative to the respective beams 302u,b and inserting the respective beam fastener into aligned holes.

A hanger 315 may be connected to an outer end of each mandrel 306 and an outer end of each housing 307 of the upper beam pair 303b. Each hanger 315 may be adjustable to suit a height of a particular pallet 215 and/or cargo 210. Each hanger 315 may include a stopper 312, an upper bracket 313, a lead screw 314, and a lower bracket 316. The upper bracket 313 may be connected to the respective outer end, such as by welding, for receiving an upper end of the lead screw 314. The upper bracket 313 may include two or more plates and a threaded hole 313n formed vertically through a top one of the plates. A thread of the lead screw 314 may correspond to a thread of the hole 313n such that rotation of the lead screw relative to the upper bracket 313 may move the lead screw vertically (upward or downward depending on rotation direction) relative to the upper bracket. The stopper 312 may be a wing nut having a thread also corresponding to that of the lead screw 314. Once the position of the lead screw 314 is set, the stopper 312 may then be rotated until the stopper shoulders against the upper bracket top plate, thereby locking the lead screw into the set position.

The lower bracket 316 may receive an upper end of the respective load line 304. The lower bracket 316 may include two or more plates and a hole 316h formed laterally through the plates. Each lower bracket 316 may be fastened to the respective load line 304 by (another) beam fastener inserted through the respective load line and the hole 316h. Each load line 304 may be a chain (shown) or a wire rope (not shown) and made any of the crane load line materials, discussed above. The lower bracket 316 may also receive a lower end of the respective lead screw 314. The lower bracket 316 may be connected to the respective lead screw 314, such as by fastening or welding. The lower bracket 316 may further include a top plate (not shown), similar to the upper bracket top plate, for the lead screw connection. The lower bracket 316 may also be ergonomically configured to be used as a handle by the driver for rotating the lead screw 314.

Alternatively, each hanger 315 may be a turnbuckle. Alternatively, as discussed and illustrated at FIGS. 3A-4G of the '184 application, a bracket 308 of the lower beam pair 303b may be used instead of each hanger 315 and the excess load line may be left to dangle.

Each of the mandrel 306 and housing 307 of the lower beam pair 303b may have a bracket 308 connected to an outer end thereof. The bracket 308 may receive a lower end of the respective load line 304. The bracket 308 may include two or more plates and a hole 308h formed laterally through the plates. Each bracket 308 may be fastened to the respective load line 304 by (another) beam fastener inserted through the respective load line and the hole 308h.

FIG. 4 illustrates operation of the sling 300 with the truck-mounted crane 100. Once the driver has backed the truck 1 into proximity of the cargo 210, the driver may park the truck. The driver may then exit the truck 1 and access the controller. The driver may then raise the boom 105 to the vertical position by operating the PCAs 110. The boom 105 may extend longitudinally away from the truck 1 in the vertical position, thereby placing the winch 115 at a position to hoist the cargo 210 located proximately behind the bumper 125. The driver may then operate the winch 115 to lower the load line 116 to the cargo 210. The driver may then fasten the sling 300 to the pallet 215 and the cargo 210.

To rig up the sling 300, the driver may measure a width of the cargo and/or pallet to determine if the beams 303u,b need to be extended (beams stowed in fully retracted position, shown). If necessary, the driver may extend the beams 303u,b. The driver may then insert the lower beams 303b into the pallet 215. The driver may then connect the sling load lines 304 to the respective brackets 308. The driver may then connect the tongue 309 to the yoke 302 and the yoke to the upper beams 303u (tongue, yoke, and beams stowed disassembled). The driver may then connect the tongue 309 (with assembled yoke 302 and upper beams 303u) to the crane load line 116 and slack the crane load line to rest the upper beams on a top of the cargo 210. If necessary, the driver may adjust the hangers 315 by measuring the height of the cargo 210 or using the load line 304 to measure the height of the cargo 210. The hangers 315 may be adjusted so that there is no or very little slack in the load lines 304. Once the hangers 315 have been adjusted, the load lines 304 may be connected to the respective hanger lower brackets 316.

The driver may then operate the winch 115 to hoist the cargo 210 and pallet 215 such that the pallet 215 is aligned with or just above the bed 120. The driver may then operate the PCAs 110 to move the boom 105 to the horizontal position. As the boom 105 is lowered to the horizontal position, the winch 115 may carry the cargo 210 and pallet 215 forward along a longitudinal path toward the cab 5 until the pallet 215 rests on the bed 120, thereby also loading the cargo 210 and pallet onto the truck 1. The winch 115 may rest at a position proximate to a rear end of the cab 5 in the horizontal position. Once in the horizontal position, the driver may secure the cargo 210 to the frame 140. The load line 116 may be left connected to the cargo 205 and serve as a back-up should the cargo break-free of tie-downs. The driver may enter the truck 1 and transport the cargo 210. Once reaching the destination, the driver may unload the cargo by reversing operation of the crane 100 and sling 300.

While the foregoing is directed to embodiments of the present invention, other and further embodiments of the invention may be devised without departing from the basic scope thereof, and the scope thereof is determined by the claims that follow.

1. A sling for lifting pallet-mounted cargo, comprising:
an upper pair of telescopic beams;
a yoke connecting the upper beams;
a lower pair of telescopic beams; and
load lines connecting each of the upper beams to a respective lower beam.

2. The sling of claim 1, further comprising adjustable hangers connecting the load lines to the upper beams.

3. The sling of claim 1, wherein:
the yoke is connected to each upper beam by a bracket and fastener, and
each fastener also connects a housing of the respective upper beam with a mandrel of the upper beam.

4. The sling of claim 1, wherein the load lines are chains.

5. The sling of claim 1, further comprising a lifting eye connected to the yoke for receiving a load line of a crane.

6. The sling of claim 5, wherein:
the lifting eye is part of a lifting tongue, and
the lifting tongue further comprises an adjustable bracket connecting the tongue to the yoke.

7. A crane, comprising:
a base, comprising:
a cargo bed welded or fastened to a frame; and
the frame for fastening to a chassis of a truck or trailer;
a boom rotatable relative to the base between a vertical position and a horizontal position;
a boom hoist operable to raise and lower the boom between the positions;
a load hoist operable to hoist the pallet-mounted cargo located proximate to a rear end of the truck or trailer when the boom is in the vertical position and operable to carry the pallet-mounted cargo toward the truck or trailer as the boom is lowered to the horizontal position, thereby loading the pallet-mounted cargo onto the cargo bed; and
the sling of claim 1 connectable to a load line of the load hoist.

8. The crane of claim 7, wherein the boom comprises:
a pair of columns pivoted to the base; and
one or more beams forming an isosceles trapezoid (minus a long base) and fastened or welded to the columns.

9. The crane of claim 8, wherein:
a length of the columns ranges from six to sixteen feet,
a width of the trapezoid ranges from five to nine feet, and
a height of the trapezoid ranges from two to six feet.

10. The crane of claim 8, wherein the boom further comprises a rail fastened or welded to each column, each rail having stake pockets formed therealong.

11. The crane of claim 7, wherein the boom hoist comprises a pair of piston and cylinder assemblies (PCAs).

12. The crane of claim 11, wherein the load hoist comprises an electric winch.

13. The crane of claim 12, further comprising a hydraulic power unit for operating the PCAs.

14. The crane of claim 7, further comprising a bumper fastened or welded to the frame.

15. The crane of claim 14, further comprising a controller disposed in a side compartment of the bumper for operation of the boom hoist and load hoist.

16. The crane of claim 7, further comprising one or more utility boxes fastened or welded to the frame.

17. A truck, comprising:
an engine;
four or more wheels, at least one wheel operably coupled to the engine;
a cab, comprising:
a steering wheel;
an accelerator pedal;
a brake pedal; and
a gear shifter;
a chassis; and
the crane of claim 7.
